(19) United States
(12) Patent Application Publication
(10) Pub. No.: US 2008/0245872 A1
(43) Pub. Date: Oct. 9, 2008

(54) BARCODE SCANNER/READER HAVING CONSTANTLY VARYING FOCAL DISTANCE

(76) Inventor: Timothy A. Good, Clementon, NJ (US)

Correspondence Address: DUANE MORRIS, LLP;IP DEPARTMENT, 30 SOUTH 17TH STREET, PHILADELPHIA, PA, 19103-4196, US

(21) Appl. No.: 11/696,828

(22) Filed: Apr. 5, 2007

(51) Int. Cl. G06K 7/10

(52) U.S. Cl. 235/462.24

(57) ABSTRACT

A scanner/reader for reading target objects, such as a barcode, that incorporates a variable focus liquid lens whose focal distance is constantly and continuously varied through the lens' predefined focal range provides an efficient way to scan or read a barcode. A driver circuit for the liquid lens continuously generates a lens driver signal that provides the liquid lens with a continuously varying voltage input to the liquid lens and thus varying the focal distance of the liquid lens cyclically through a predefined focal range.

### FIELD OF THE INVENTION

The present invention relates to barcode scanners and readers.

### BACKGROUND

Barcode readers or scanners are found in many commercial environments such as, for example, point-of-sale stations in retail stores and supermarkets, inventory and document tracking, and diverse data control applications. To meet the growing demands, barcode symbol readers of various types have been developed for scanning and decoding barcode symbol patterns and producing symbol character data for use as input in automated data processing systems. Barcode scanners generally are available in handheld, hands-free or in-counter formats.

Typical laser barcode scanners have a fixed focus of the laser beam which puts a limitation on the depth of field (DOF) and resolution of the scanner needed to read a barcode. Imaging scanners and engines often employ CMOS or CCD sensors coupled to fixed focus optics, or optics with preset focus locations that the user can select offline. Such conventional auto focus scanners heretofore have typically used lens systems employing mechanical movements and multiple moving parts to vary the focal length of the lenses, which are typically glass or plastic. The field of view (FOV) of these imaging devices have fixed angles so that the size (width) of view varies depending on the distances of the target from the image device. In applications such as barcode scanning, this poses a significant challenge for the user to capture the desired target entirely and consistently with satisfactory resolution to read the barcode, even aided with mechanical targeting and framing apparatus. Therefore, in order to bring the barcode into focus for reading, the user must sometimes resort to either moving the target object with barcode to be scanned in the case of fixed-mount scanners, or moving the scanner itself in the case of handheld scanners, until the barcode is read. Both scenarios are cumbersome for the user, increases scanning time, and reduces overall scanning efficiency.

In some barcode scanning systems, some functional improvements have been achieved by implementing conventional mechanical autofocusing/zooming lens mechanism in conjunction with IR transceiver distance detection. However, the bulkiness of the autofocus mechanism and the associated control circuitry typically do not permit compact equipment packages to be created such as those required for handheld scanners or scanning engine products. Furthermore, the autofocusing system requires some type of distance detection means to provide the information on the distance to the target for the autofocus system adding additional components and complexity to the barcode scanning system.

Recent developments in optics have produced very compact variable-focus liquid lens technology that has no mechanical moving parts. Because of the compact design and low power consumption attributes, such liquid lens technology is well suited for barcode scanning applications. A fluid or liquid lens has no moving parts and the focus is simply controlled by a voltage change. Compared to conventional moving-part mechanical lens systems, a liquid lens system therefore advantageously has fast focusing/zooming capabilities and is inherently more reliable owing to its simple design. In addition, a liquid lens can be made relatively small in size with typical diameters of about 3 mm in some embodiments.

A liquid lens generally includes two immiscible (non-mixable) fluids each having a different refractive index. One fluid is an electrically conducting liquid, typically water. The other fluid is typically an electrically non-conducting oil. The fluids are contained in a cylinder or short tube that has a hydrophobic coating applied to the inner walls and two optically clear ends through which light can pass. A meniscus is formed at the interface between the water and oil that has a hemispherical shape and functions like a spherically curved optical lens.

The focal length of a liquid lens is controlled by changing the shape of the meniscus via applying an electric field across the hydrophobic coating to vary the degree of hydrophobic or water-resistant property. This technique is referred to as electrowetting, which uses electrical charge to control the surface tension of the water. The change in surface tension alters the radius of curvature of the meniscus between the two fluids and hence the focal length of the lens. By varying the electric signal or voltage to the liquid lens, the curvature of the meniscus or lens can concomitantly be varied from an initial convex shape in one position to concave in another position and every shape therebetween including flat. The lens shape transitions are effected smoothly and quickly, without any moving parts. A liquid lens may be coupled with CCD or CMOS to create compact image reading and capture devices. Because a liquid lens represents a capacitive load, power consumption is relatively small making it suitable for battery-powered and rechargeable devices. However, in barcode scanning applications, the problem of effectively and quickly determining the distance to the target barcode and adjusting the focus of such devices still remain. Accordingly, a further improvement is desired in barcode scanners.

### SUMMARY

According to an embodiment, an improved laser scanner incorporating a variable focus liquid lens enabling the scanner to readily read target images at various distances from the laser scanner is disclosed. The laser scanner comprises a housing that contains the relevant components of the scanner and a laser source provided within the housing for generating a laser beam for scanning a target image. A variable focus liquid lens is also provided within the housing and positioned such that the scanning laser beam is transmitted through the liquid lens on its way to the target image. The variable focus liquid lens is of the type whose focal distance is adjustable by varying an input voltage to the liquid lens. A driver circuit for the liquid lens is also provided in the laser scanner that continuously generates a lens driver signal that provides the liquid lens with a continuously varying voltage input to the liquid lens and varying the focal distance of the liquid lens cyclically through a predefined focal range. The result is that when the target object is presented to the scanner at a distance that is within the predefined focal range, the target object is read when the liquid lens reaches an optimal focal distance for the target object. The specifics of the input voltage profile would depend on the particular liquid lens utilized and its characteristics. For a given liquid lens, the input voltage profile would be determined to continuously vary the focal distance of the liquid lens with minimal perturbations in the light being transmitted through and being focused by the liquid lens.

The predefined range of focal distances (hereinafter referred to as the “focal range” of the scanner) is selected to encompass substantially the full range of possible target image distances the scanner would typically encounter during actual use in the field condition. In other words, the predefined focal range is sufficiently large so that when a target object is presented to the scanner by a user to be read by the scanner, there would rarely be a situation where the target object is outside the predefined focal range of the liquid lens. Thus, when a target object is presented to the laser scanner at a distance that is within the predefined focal range of the scanner, the target object will be in focus at some point (when the liquid lens' focal distance matches the optimal focal distance for the target object) as the scanner is continuously cycling through its focal range and the target object will be identified by the scanner. In one embodiment, the target object is a barcode.

According to another embodiment, a method of reading a target object with a laser scanner is disclosed. The method comprises providing a laser scanner having a variable focus liquid lens whose focal distance is adjustable by varying an input voltage to the liquid lens, projecting a scanning laser beam through the liquid lens toward a target image and continuously varying the focal distance of the liquid lens cyclically through a predefined range of focal distances. Then when a target object, such as a barcode, is presented to the laser scanner, at a distance that is within the predefined range of focal distances, the target object is discerned/read when the liquid lens reaches an optimal focal distance for the target object.

According to another embodiment, a method of reading a target object with an image reader is also disclosed. The method comprises providing the image reader with a variable focus liquid lens wherein the image reader is configured so that the image reader's image sensor views the target object through the variable focus liquid lens. The focal distance of the liquid lens is constantly varied cyclically through a predefined focal range. Then when a target object is presented to the image reader, the image of the target object is focused on to the image sensor when the liquid lens reaches an optimal focal distance for the target object.

The apparatus and method disclosed herein advantageously provides a liquid lens system and laser scanners and image readers incorporating such liquid lens system for improved object scanning. Such liquid lens system is compact and light-weight and, thus, can be incorporated into fixed-mount laser scanners and image readers as well as portable handheld scanners and image readers.

### BRIEF DESCRIPTION OF THE DRAWINGS

The features of the preferred embodiments will be described with reference to the following drawings where like elements are labeled similarly, and in which:

FIG. 1 is a schematic diagram of a laser barcode scanner according to an embodiment;

FIG. 2 is a schematic diagram of a barcode reader according to another embodiment;

FIGS. 3A, 3B and 3C are schematic, cross-sectional views of a variable focus liquid lens of the related art;

FIG. 4 is a schematic diagram of a liquid lens driver useable with the liquid lens of FIG. 3 according to an embodiment;

FIG. 5 is a plot showing curves representing resolution/spot size versus target distance from a lens and thereby showing the full potential depth of field (DOF) according to an embodiment.

All drawings are schematic and are not drawn to scale.

### DETAILED DESCRIPTION

This description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,”, “above,” “below,” up, “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation, The terms “circuitry” or “circuit” as used herein means any combination of hardware, firmware, or software used to implement the functions or control of component(s) described herein. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features; the scope of the invention being defined by the claims appended hereto.

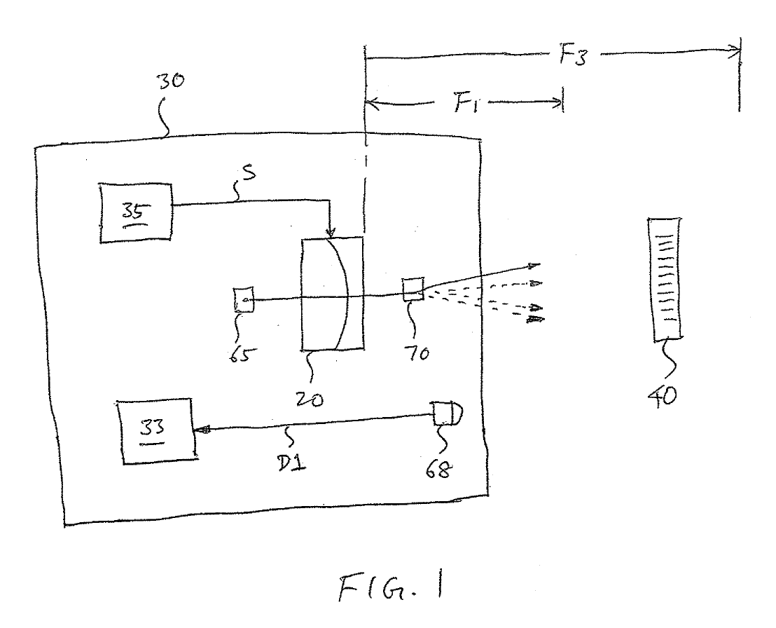

FIG. 1 is a schematic depiction of a laser barcode scanner 30 according to an embodiment. The laser barcode scanner 30 can be one of many conventionally available laser barcode scanners well known in the art and the workings of such barcode scanner and the components will only be described and discussed herein to the extent necessary to explain the invention. More detailed description of the workings of an example of a laser barcode scanner can be found in a U.S. Pat. No. 5,340,973 to Knowles et al. the content of which is hereby incorporated by reference. The laser barcode scanner 30 comprises a light source 65 which, in general, may be any source of intense light suitably selected for maximizing the reflectivity from the target object's surface bearing the barcode symbol. In the illustrative embodiment, light source 65 comprises a solid-state visible laser diode (VLD). In order to repeatedly scan the laser beam 66 produced by the VLD 65 over a scan field in front of the laser barcode scanner 30, an appropriate means for scanning the laser beam is utilized. Such means can be, for example, a flipper mechanism 70, mirrored polygon, holographic deflector, etc. The flipper mechanism 70 generally comprises one or more mirrors to bend and direct the laser beam 66 towards the target barcode symbol 40 in the scan field. Generally, at least one of the mirrors employed in the flipper mechanism 70 is configured and adapted to oscillate at a predetermined desired frequency, thus, scanning the laser beam 66 back and forth across the scan field.

When a barcode symbol 40 on an object is within the scan field at the time of scanning, the incident laser light 66 on the barcode will be scattered and reflected. This scattering/reflection process produces a laser light return signal of variable intensity which represents a spatial variation of light reflectivity characteristic of the spaced apart pattern of bars comprising the barcode symbol. The photoreceiving device 68 detects at least a portion of the reflected laser light of variable intensity. Upon detection of this reflected laser light, the photoreceiving device 68 produces an analog scan data signal D1 indicative of the detected light intensity.

Although the photoreceiving device 68 is only schematically illustrated in FIG. 1, the photoreceiving device 68 may comprise laser light collection optics which focus reflected laser light on to the photoreceiving device 68 for better detection. A frequency selective filter may also be incorporated which only transmit optical radiation of wavelengths in a narrow band that matches the wavelength of the laser beam produced by the VLD 65. The analog scan data signal D1 produced by the photoreceiving device 68 is received by the scanner's microprocessor circuit 33 to be further processed to detect and decode the barcode symbol 40. This further processing of the scan data signal D1 is well known in the art and for the purposes of describing the present invention, the data processing need not be further elaborated. The processing of the scan data signal D1 by the microprocessor circuit 33 will be hereinafter referred to as “reading” the target object, such as a barcode symbol. And the barcode symbol will be referred to as having been “read” when the processing of the scan data signal D1 results in a recognition and decoding of the barcode symbol.

According to an embodiment, in addition to the components that would be found in a typical laser barcode scanner to make it operable, the laser barcode scanner 30 includes a variable focus liquid lens 20 that is provided between the VLD 65 and the flipper mechanism 70. A liquid lens driving circuit 35 is also provided to continuously vary the focal distance of the liquid lens. By cyclically varying the focal distance of the liquid lens 20 continuously back and forth through a range of focal distances defined by two focal distances F₁ and F₃, the laser barcode scanner 30 will always be able to hit the optimal focal distance for any given target barcode symbol that is placed in front of the laser scanner within the focal range of the laser scanner defined by distances F₁ and F₃. And thus, by varying the focal distance of the liquid lens 20 through its focal range with a sufficiently high frequency, the barcode symbols can be scanned quickly regardless of the particular distance the object bearing the barcode symbol is from the scanner. The focal range of the barcode scanner 30 is preferably defined to be broad enough to encompass all or sufficiently large majority of the typical distance to the target barcode symbol encountered during use.

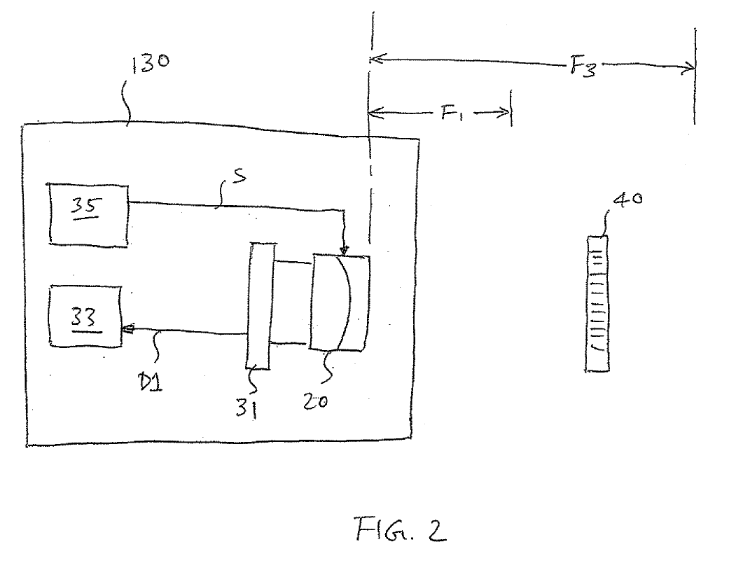

FIG. 2 is a schematic depiction of a barcode image reader 130 according to an embodiment. The barcode reader 130 functions much like a digital photographic camera and can be one of many conventionally available barcode readers well known in the art. The workings of such barcode image reader is well known in the art and the workings and its components will only be described and discussed herein to the extent necessary to explain the invention. The barcode image reader 136 comprises a pixilated full array image capture sensor 31, such as a CCD (charge coupled device) or a CMOS (complementary metal-oxide semiconductor) sensor that essentially converts sensed or received light energy from the target image into electrical charges. Generally, the barcode image reader 130 also include some means to illuminate the target image. The illumination source can be any one of appropriate illuminating devices such as a laser, an LED, or a light bulb, etc. When an image is focused on to the image sensor it sends an image data D1 to the microprocessor 33 of the barcode image reader 130. The image data D1 is then further processed to recognize and decode the barcode image. As stated earlier in reference to the laser barcode scanner embodiment, when an image of a barcode symbol is properly focused on the image sensor 31, the process of processing, recognizing and decoding of the barcode symbol will be herein referred to as “reading” the barcode. And the barcode will be referred to as having been “read” when the process successfully recognizes and decodes the barcode symbol. According to an embodiment, a variable focus liquid lens 20 is provided in front of the image sensor 31. Unlike the conventional barcode image readers, in which an autofocusing lens mechanisms is provided in front of the image sensor to enable the barcode image readers to focus onto the barcode symbols, in the barcode reader 130, the liquid lens 20 is driven by an oscillating driver circuit 35 continuously varying the focal distance of the liquid lens. The focal distance of the liquid lens 20 is cyclically and continuously varied back and forth through a range or continuum of focal distances defined by two focal distances F₁ and F₃. As with the laser barcode scanner 30 embodiment, the barcode image reader 130 will always be able to focus on to and recognize any given target barcode symbol that is placed in front of the barcode reader as long as the target barcode symbol is within the focal range of the barcode reader defined by distances F₁ and F₃. The focal range of the barcode reader 130 is preferably defined to be broad enough to encompass all or sufficiently large majority of the typical distance to the target barcode symbol encountered during use.

And thus, by blindly varying the focal distance of the liquid lens 20 through its focal range continuously and cyclically with a sufficiently high frequency, the barcode symbols can be read quickly no matter how far the barcode is from the barcode reader 130 as long as the barcode is within the focal range of the barcode reader's liquid lens. However, the focal distance cannot be varied too quickly with respect to the image acquisition rate of the image sensor 31. The speed at which the focal distance is varied should be moderately slow compared to the exposure frequency of the image sensor 31 so that although the focal distance is constantly changing, it doesn't change enough during the exposure time of the image sensor 31 to cause the barcode image to be too out of focus to be recognized.

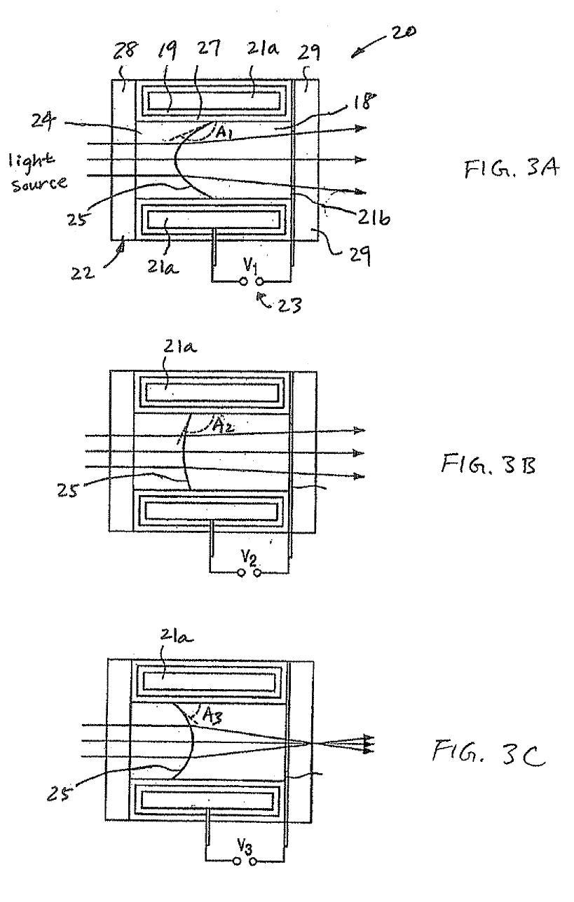

In an alternate embodiment, the focal distance of the liquid lens 20 may be changed through its focal range in discrete steps, rather than continuously changing, so that the barcode image reader is fixed at a focal distance for a duration matching the exposure time of the image sensor 31 before changing to next focal distance. This embodiment, however, requires synchronized coordination between the liquid lens driver 35 and the image sensor circuit. The liquid lens driver 35 would be configured to output the lens driver signal S that is incrementally stepped through a range of voltage values that correspond to the focal range of the liquid lens 20. The relationship between the liquid lens driving voltage and the focal distance of the liquid lens is described further below in reference to the FIGS. 3A-3C.

Referring to FIGS. 3A, 3B, and 3C, schematic diagrams are shown of one possible embodiment of the liquid lens 20 useable with the various embodiments of the autofocus scanner systems described herein. The liquid lens 20 includes a hollow cylindrical body 22 defining a cylindrical fluid chamber 18 and having two sealed ends 28, 29 which necessarily are transparent to allow the passage of light energy. The fluid chamber 18 is filled with two fluids 24, 26 having different indexes of refraction. The two fluids 24, 26 are immiscible and, thus, stay separated in the chamber 18 and form a meniscus 25. A hydrophobic fluid contact layer 27 forms the inside wall of the chamber 18. A pair of electrodes 21a, 21b are provided and are connected to an electric energy source 23 and a driving circuit that supplies a driving voltage signal to the liquid lens 20. The first electrode 21a is of a cylindrical shape and coated by an insulating layer 19 so that it is electrically insulated from the fluid contact layer 27. The second electrode 21b is electrically connected to the fluid contact layer 27.

The first of the two fluids 24 is an insulating fluid such as an oil in one embodiment and the second fluid 26 is a conducting fluid such as water. By applying a driving voltage signal to the electrodes 21a, 21b, thus creating an electrical potential across the electrodes 21a, 21b the curvature of the meniscus 25 can be controlled. The meniscus 25 acts as a curved optical lens and by controlling the curvature of the meniscus along a continuum of positions from concave (FIG. 3A) to convex (FIG. 3C) by varying the driving voltage signal to the electrodes 21a and 21b, the focal point (i.e. the focal distance) of the liquid lens 20 can be varied accordingly. As illustrated, the meniscus 25 can be controlled to meet the inside wall 27 of the lens body 22 at variable angles of contact A₁ to A₃ by varying the driving voltage signal from V₁ to V₃. Such liquid lenses are presently commercially available from companies such as Varioptics S.A. and Philips Electronics and the driving voltage to focal distance profile for any given liquid lens is readily available from the lens manufacturer.

Thus, for example, if the angles of contact A₁ and A₃ for the meniscus 25 were to define the desired focal range F₁ to F₃ of the liquid lens 20 that is desired for a particular barcode scanner/reader application according to an embodiment, the liquid lens driving circuit 35 would be configured to produce an output signal S, the lens driving signal, that will continuously cycle back and forth between the two voltage levels V₁ to V₃ corresponding to the meniscus angles of contact A₁ and A₃. Because the focal distance of the liquid lens should change along a continuum of focal distances between F₁ and F₃, rather than flip flopping between the two values, the liquid lens driving circuit would preferably be configured to produce the lens driving signal S that varies between the two voltage levels V₁ to V₃ in a continuum. In an embodiment, the lens driving signal S would be produced to constantly vary between the two voltage levels V₁ to V₃ back and forth in a periodic sinusoidal fashion, for example. However, the exact shape of the periodic waveform can be optimized and customized to produce the most well-behaved dynamic performance of the meniscus 25 throughout its range of focus. The particular waveform and the voltage levels V₁ to V₃ would largely be dependent on the characteristics of the particular variable focus liquid lens used and for a given variable focus liquid lens.

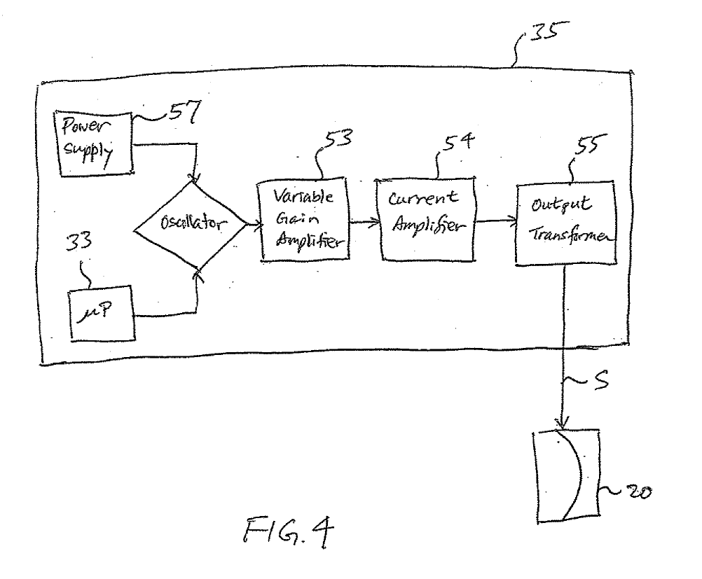

Referring to the block diagram of FIG. 4, an example of the liquid lens driver circuit 35 is illustrated. The liquid lens driver circuit 35 generally includes in sequence a power supply 57 with voltage regulators, sinusoidal wave oscillator 52 which may be a 1 kHz oscillator in one embodiment, variable gain amplifier 53, current amplifier 54, and output transformer 55. The output transformer produces the liquid lens driver signal S. In one embodiment, the transformer 55 may include a 2×5V primary transformer and 230V secondary transformer. In one embodiment, a representative typical output from the transformer 55 may be without limitation 0-60 Vrms @ 1 kHz sinusoidal. The output voltage from the transformer 55 to liquid lens 20 is ultimately adjusted by controlling the sinusoidal wave oscillator 52. The sinusoidal wave oscillator 52 is configured to generate a constantly varying output that regulates the correspondingly constantly varying liquid lens driver signal S output of the transformer 55. Because the laser barcode scanner 30 and the barcode reader 130 embodiments are always and constantly blindly varying the focal distance of their respective liquid lens 20, the liquid lens driver signal S does not need to be turned off. However, alternatively, the sinusoidal wave oscillator 52 can be configured to be turned on or off by the microprocessor 33 of the barcode scanner/reader systems 30, 130.

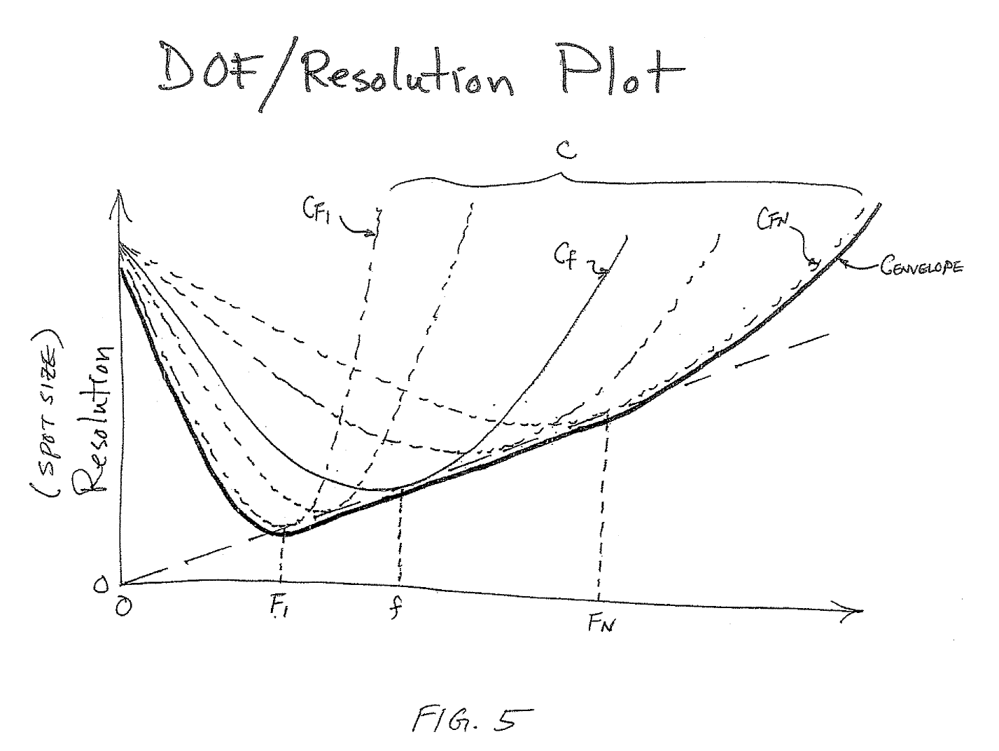

The plot of FIG. 5 shows laser barcode scanner's resolution (i.e. the laser beam spot size) with respect to distance of the target barcode image from the liquid lens provided in a laser barcode scanner such as the scanner 30 of FIG. 1. A series of curves C are shown with each independent curve representing a laser beam Gaussian profile with a given fixed focal distance as may be used in a barcode scanner in some embodiments. In essence, each curve C represents the size of the laser beam spot produced by the scanner as a function of the distance from the laser beam focusing lens for a fixed lens shape (i.e. a constant drive voltage). As the drive voltage changes the lens shape varies, and the troughs of each curve C indicate the varying focal distances produced by the changing lens shape.

Generally, the ability of a laser barcode scanner to scan the target barcode is greatest with the smallest laser beam spot size. This would be when the target barcode is at the focal distance of the laser beam. The smaller the laser spot size produced, the greater the ability of the scanner to resolve the smaller individual barcode elements present in higher-density barcodes. For example, considering the curve C_{f} representing the resolution curve for a lens which produces a beam having a fixed focal distance f, a barcode scanner using that focusing lens would have the best resolution when the target barcode symbol is at distance f from the focusing lens. As the target barcode symbol moves away from the distance f in either direction, the scanner's ability to resolve the barcode diminishes quickly. In other words, such fixed focal distance laser barcode scanner would have an optimal resolving distance that is substantially equal to the fixed focal distance f of the laser beam produced by the focusing lens.

In contrast, consider a variable focus liquid lens 20 discussed herein that has a focal range between focal distances F₁ and F_{N}. The curves CF₁ and CF_{N} in FIG. 5 represents the resolution plots associated with the two limits of the focal range for the variable focus liquid lens 20. And as disclosed herein, this liquid lens 20 is incorporated in the laser barcode scanner 30 described above and continuously cycled back and forth through its focal range F₁ to F_{N} according to an embodiment of the invention. As the variable focus lens 20 is continuously varied through its focal range, it would effectively exhibit the full range of resolution curves CF₁ through CF_{N}. The result is that for such variable focus liquid lens 20 whose focal distance is constantly being varied through its focal range, the lens' effective resolution curve is the envelope curve C_{ENVELOPE} shown in FIG. 5. While the full envelope of the resolution curve represented by C_{ENVELOPE} can not be achieved entirely at any given time, that curve represents the full range of focal distances the lens will cycle through between the focal distances F₁ and F_{N}. Thus, the Curve C_{ENVELOPE} represents the effective depth-of-field (DOF) curve for the variable focus liquid lens 20 that is constantly changing through its focal range. No matter how far the target barcode image is from the barcode scanner, as long as the target image is somewhere within the focal range of the liquid lens 20, the scanner will be able to resolve it within one sweep through its focal range.

According to another embodiment, a method of reading a target object with a laser scanner is disclosed. The method comprises providing a laser scanner having a variable focus liquid lens whose focal distance is adjustable by varying an input voltage to the liquid lens, projecting a scanning laser beam through the liquid lens toward a target object while continuously varying the focal distance of the liquid lens cyclically through a predefined range of focal distances. Then when a target object, such as a barcode, is presented to the laser scanner, at a distance that is within the predefined range of focal distances, the target object is discerned/read when the liquid lens reaches an optimal focal distance for the target object.

The apparatus and method disclosed herein advantageously provides a liquid lens system and laser barcode scanners and barcode readers incorporating such liquid lens system for improved scanning. Such system allows a quick efficient scanning/reading of a target object such as a barcode at varying distances from the scanner without the user moving around the target object. Such liquid lens system is compact and light-weight and, thus, can be incorporated into fixed-mount laser scanners as well as portable handheld scanners such as handheld barcode scanners.

Another benefit of the laser barcode scanner disclosed herein is that it overcomes the resolution problems for laser barcode scanners associated with paper noises. In applications where the barcode symbols are on rough grain papers, the reflected laser beam intensity changes as the beam crosses the paper grains, creating a noise “signal” in addition to the signals representing the bar symbols. In such situations, smaller laser beam spot size (i.e., at the focal distance of the laser beam focusing lens) may not necessarily be desired for optimal reading of barcodes. A larger laser beam spot that forms away from the focal distance of the laser beam focusing lens may provide a cleaner signal. But, in the laser barcode scanner that comprises a variable focus liquid lens whose focal distance is constantly and cyclically varied, this problem is transparent. At some point, the liquid lens will be in a lens configuration with a focal distance that is optimal for reading the barcode whether that optimal point is when the laser beam is in focus on the barcode or slightly off focus. Because the focal distance of the liquid lens is blindly varied constantly, the scanner/reader and the user need not be concerned with how far the target object is from the scanner/reader.

While the foregoing description and drawings represent preferred or exemplary embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments. Rather, the appended claims should be construed broadly, to include other variants and embodiments of the invention, which may be made by those skilled in the art without departing from the scope and range of equivalents of the invention.

What is claimed is:

1. A laser scanner for scanning a target object comprising:
a housing;
a laser source provided within the housing for generating a laser beam for scanning the target object;
a variable focus liquid lens having a predefined focal range and a focal distance at a given moment in time provided within the housing and positioned such that the laser beam is transmitted through the liquid lens on its way to the target image, the focal distance of the liquid lens being adjustable by varying an input voltage to the liquid lens;
a driver circuit for the liquid lens generating a lens driver signal that provides continuously varying voltage input to the liquid lens and thus varying the focal distance of the liquid lens constantly and cyclically through the predefined focal range, wherein when the target object is presented to the scanner at a distance that is within the predefined focal range, the target object is read when the liquid lens reaches an optimal focal distance for the target object.

2. The laser scanner of claim 1, wherein the predefined focal range of the variable focus liquid lens is defined to encompass substantially the full range of possible target object distances the laser scanner encounters.

3. An image reader reading a target object comprising:
a housing;
an image sensor provided within the housing for capturing an image of the target object;
a variable focus liquid lens having a predefined focal range and a focal distance at a given moment in time provided within the housing in front of the image sensor wherein the target image is focused onto the image sensor by the variable focus liquid lens, the focal distance of the liquid lens being adjustable by varying an input voltage to the liquid lens; and
a driver circuit for the liquid lens generating a lens driver signal that provides the liquid lens with a continuously varying voltage input to the liquid lens and varying the focal distance of the liquid lens cyclically through the predefined focal range, wherein when the target image is presented to the image reader at a distance that is within the predefined focal range, the target image is focused on to the image sensor when the liquid lens reaches an optimal focal distance for the target object.

4. The image reader of claim 3, wherein the predefined focal range of the variable focus liquid lens is defined to encompass substantially the full range of possible target object distances the image reader encounters.

5. A method of reading a target object with a laser scanner that comprises a variable focus liquid lens whose focal distance is adjustable by varying an input voltage to the liquid lens, said method comprising:
projecting a laser beam through the liquid lens toward a target object while continuously varying the focal distance of the liquid lens cyclically through a predefined focal range, wherein the target object presented to the laser scanner is read by the laser scanner when the liquid lens reaches an optimal focal distance for the target object.

6. The method of claim 5, further comprising a step of determining the focal range for the variable focus liquid lens to encompass substantially the full range of possible target object distances the laser scanner encounters.

7. A method of reading a target object with an image reader that contains an image sensor, said method comprising:
providing the image reader with a variable focus liquid lens whose focal distance is adjustable by varying an input voltage to the liquid lens, wherein the image sensor views the target object through the variable focus liquid lens while continuously varying the focal distance of the liquid lens cyclically through a predefined focal range, wherein the target image presented to the image reader is focused on to the image sensor when the liquid lens reaches an optimal focal distance for the target object.

8. The method of claim 7, further comprising a step of determining the focal range for the variable focus liquid lens to encompass substantially the full range of possible target object distances the image reader encounters.
